(19) United States
(12) Patent Application Publication
(10) Pub. No.: US 2023/0379363 A1
(43) Pub. Date: Nov. 23, 2023

(54) PROXY DETECTION SYSTEMS AND METHODS

(71) Applicant: AMADEUS S.A.S., Biot (FR)

(72) Inventors: Elisa CHIAPPONI, Antibes (FR); Marc DACIER, Thuwal (SA); Olivier THONNARD, Grasse (FR); Vincent RIGAL, Antibes (FR); Mohamed FANGAR, Nice (FR)

(21) Appl. No.: 17/746,556

(22) Filed: May 17, 2022

(51) Int. Cl. H04L 9/40; H04L 43/106

(52) U.S. Cl. CPC H04L 63/166; H04L 63/168; H04L 63/20; H04L 43/106

(57) ABSTRACT

A proxy detection method includes: in response to receiving, from a client device, a first request to establish a transport-layer connection between the client device and the server, transmitting a first message to the client device according to a first handshake sequence, for establishing the transport-layer connection; determining a first time period associated with completion of the first handshake sequence; in response to receiving, from the client device over the transport-layer connection, a second request to establish a secure link between a client endpoint and the server, transmitting a second message to the client endpoint according to a second predefined handshake sequence, for establishing the secure link; determining a second time period associated with completion of the second handshake sequence; and generating, based on the first time period and the second time period, a score indicating a likelihood that the client device is a proxy for the client endpoint.

### BACKGROUND

Servers receive and respond to requests from client devices, e.g., to deliver data requested by the client devices in connection with web-based services. For certain services, responding to such requests can be computationally intensive. For example, servers handling search requests for travel-related services (e.g., flights, hotels, and the like) may incur significantly higher computational costs to generate responses to such requests than the costs incurred by other servers responsible for the retrieval of previously generated and indexed data.

The operators of the above-mentioned servers may derive little or no return for the cost of servicing fraudulent or abusive client requests. Upon detecting such requests, discarding or otherwise altering the usual request handling process may therefore be desirable, to reduce the allocation of computational resources to responding to such requests, with little likelihood of return, e.g., in the form of travel services being purchased from the server's operator. Fraudulent or abusive client requests, however, may be routed through proxy devices, which complicates their detection. Detecting such requests may be particularly challenging when the proxy devices are residential or other consumer-level devices that may also originate legitimate requests.

### SUMMARY

An aspect of the specification provides a proxy detection method in a server, the method including: in response to receiving, from a client device, a first request to establish a transport-layer connection between the client device and the server, transmitting a first message to the client device according to a first handshake sequence, for establishing the transport-layer connection; determining a first time period associated with completion of the first handshake sequence; in response to receiving, from the client device over the transport-layer connection, a second request to establish a secure link between a client endpoint and the server, transmitting a second message to the client endpoint according to a second predefined handshake sequence, for establishing the secure link; determining a second time period associated with completion of the second handshake sequence; and generating, based on the first time period and the second time period, a score indicating a likelihood that the client device is a proxy for the client endpoint.

Another aspect of the specification provides a server, including: a communications interface; and a processor configured to: in response to receiving, from a client device, a first request to establish a transport-layer connection between the client device and the server, transmit a first message to the client device according to a first handshake sequence, for establishing the transport-layer connection; determine a first time period associated with completion of the first handshake sequence; in response to receiving, from the client device over the transport-layer connection, a second request to establish a secure link between a client endpoint and the server, transmit a second message to the client endpoint according to a second handshake sequence, for establishing the secure link; determine a second time period associated with completion of the second handshake sequence; and generate, based on the first time period and the second time period, a score indicating a likelihood that the client device is a proxy for the client endpoint.

### BRIEF DESCRIPTIONS OF THE DRAWINGS

Embodiments are described with reference to the following figures.

FIG. 1 is a diagram illustrating a communications system.

FIG. 2 is a diagram illustrating certain internal components of the proxy detector of FIG. 1.

FIG. 3 is a flowchart of a proxy detection method.

FIG. 4 is a diagram illustrating an example performance of the method of FIG. 3.

FIG. 5 is a diagram illustrating another example performance of the method of FIG. 3.

### DETAILED DESCRIPTION

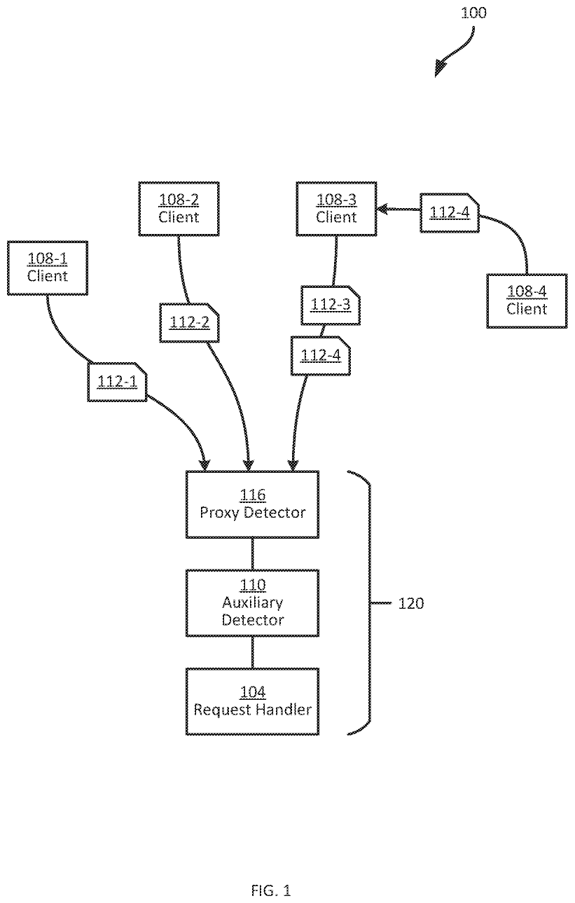

FIG. 1 depicts a communications system 100, including a request handler 104 and a plurality of client devices, referred to collectively as client devices 108 and generically as a client device 108. In the illustrated example, the system 100 includes four client devices 108-1, 108-2, 108-3, and 108-4, although it will be understood that the system 100 can include greater and smaller numbers of client devices 108 in other examples. The client devices 108 are computing devices such as desktop computers, smart phones, laptop computers, or the like. Each client device 108 thus includes suitable hardware elements, such as processing, storage and network communications components, as well as input and output devices (e.g., keyboards, touch panels, displays, and the like), enabling the client device 108 to communicate with the request handler 104 over a network or combination of networks. Communications between the client devices 108 and the request handler 104 include the transmission of requests from client devices 108 to the request handler 104, and the generation and transmission of responses to such requests from the request handler 104 to the relevant client devices 108.

The request handler 104 can be implemented as a server or set of servers, configured to receive and process requests from the client devices 108. The request handler 104 therefore includes processing and storage hardware components, e.g., executing suitable software to receive and interpret client requests, as well as to generate and return response data to such requests. The requests may include, for example, search requests for travel-related goods or services, such as search requests for flights between specified origin and destination locations (e.g., particular cities or airports), on specified days, or the like. In order to generate response data for a client request, the request handler 104 can be configured to retrieve and process data from various repositories and/or interact with other computing devices (e.g., operated by airlines, or the like), to generate combinations of flights that satisfy search parameters set out in the client request.

The generation of response data can be computationally complex, as the availability and pricing of flights may be highly variable and dependent on the identity of an operator of the client device 108, among other factors. The costs (e.g., in terms of financial commitments, staffing, and the like) of the computational resources (e.g., processing time, storage capacity, and the like) allocated to handling search requests from the client devices 108 may be supported in part by purchases of the above-mentioned flights by operators of the client devices 108. Some client requests, however, are highly unlikely to lead to such purchases, and committing computational resources to generate responses to those requests may therefore not be desirable.

For example, some client requests are originated by scraper bots, and the results generated by the request handler 104 may be used to populate third-party search engines, storefronts, or the like, thus potentially depriving the operator of the request handler 104 of at least some of the financial return associated with those search results, while still having incurred the computational cost of generating the search results. As will be apparent to those skilled in the art, bot-originated requests are not the only type of client request that it may be desirable to detect and handle differently from other client requests. Such requests are simply discussed herein as an illustrative example.

Bot-originated requests such as those mentioned above, and/or other client requests that the operator of the request handler 104 may seek to detect and handle differently from other requests, may be detected based on the content of the requests, attributes of the requests' senders, or the like. The system 100 may include, for example, an auxiliary detector 110, e.g., in the form of an additional server or set of servers, and/or additional application(s) expected by the request handler 104. The auxiliary detector 110 is configured to process incoming requests 112 to determine whether each request 112 is likely to have originated from a bot or other source for which differential handling is desired (e.g., sources presenting security risks, engaging in fraudulent behavior, or the like). A request may therefore be forwarded to the request handler 104 for further processing, for example, only if the auxiliary detector 110 determines a low likelihood that the request originated from a bot.

Bot-originated requests, however, may be obfuscated from detection by the auxiliary detector 110 by routing such requests through proxies. For example, the client devices 108-1 and 108-2 are shown transmitting respective requests 112-1 and 112-2 to the request handler 104 in FIG. 1; the requests 112-1 and 112-2 are generated at the client devices 108-1 and 108-2 themselves. The client device 108-3, on the other hand, is shown transmitting distinct requests 112-3 and 112-4 to the request handler 104. The request 112-3 may be generated at the client device 108-3, e.g., via input data provided by an operator of the client device 108-3. The request 112-4, however, originated not at the client device 108-3, but at a distinct client device 108-4 employing the client device 108-3 as a proxy. In some examples, additional computing devices may handle the request 112-4 between the client device 108-4 and the client device 108-3. For example, a superproxy (not shown) can be configured to receive instructions from the client device 108-4 (e.g., executing a scraper bot application) and generate numerous individual requests for transmission via distinct proxies such as the client device 108-3.

Various mechanisms are available to detect proxied requests 112 (e.g., filtering requests based on blacklisted Internet Protocol (IP) addresses, or the like). Those mechanisms, however, may only detect a portion of proxied requests. Further, effectiveness of those detection mechanisms may be reduced for certain forms of proxied request. In the illustrated system, for example, the client device 108-3 is referred to as a residential proxy, in that the client device 108-3 is a consumer-level computing device that is unlikely to trigger conventional proxy-detection mechanisms. The client device 108-3, as seen above, can also originate legitimate (e.g., not bot-originated) requests that are preferably processed by the request handler 104 in the same manner as the requests 112-1 and 112-2, in addition to proxied requests for which modified handling may be desirable.

To detect proxied requests in general, and requests routed via residential proxies in particular, the system 100 therefore also includes a proxy detector 116. The proxy detector 116 can be implemented as a distinct computing device (e.g., one or more servers) from the auxiliary detector 110 and the request handler 104. In other examples, the proxy detector 116 can be implemented as an additional software application executed at the computing device(s) implementing the auxiliary detector 110 or the request handler 104. As will be discussed below in greater detail, the proxy detector 116 is deployed as the first entity in the request-handing infrastructure (labelled as a request-handling subsystem 120 in FIG. 1) with which the client devices 108 communicate. That is, transport-layer connections and secure links are established between the client devices 108 and the proxy detector 116, rather than between the client devices 108 and the auxiliary detector 110 or request handler 104.

As will be apparent, the client requests 112 are generally implemented as sequences of messages, e.g., to establish communications between a client device 108 and the proxy detector 116, to serve web content or the like to the client device 108, and to receive the above-mentioned search request from the client device. Establishing communications between a client device 108 and the proxy detector 116 typically involves establishing a transport-layer connection, e.g., based on the Transport Control Protocol (TCP) or another suitable transport-layer protocol. Once the transport-layer connection is established, a secure link is established over the transport-layer connection, e.g., based on the Transport Layer Security (TLS) protocol, Secure Sockets Layer (SSL) protocol, or the like. Web content, search requests, response data and the like, can then be exchanged over the secure link.

The proxy detector 116 is configured to inspect at least some of the above-mentioned messages to determine whether the client device 108 is likely to be operating as a proxy. In particular, as will be discussed below in greater detail, the transport-layer connection is established between the proxy detector 116 and the client device 108 as the nearest transport-layer device (i.e., ignoring routing hardware implementing link-layer and other lower-level functions). The secure link, however, is established with the ultimate client endpoint, e.g., the device executing the web browser or other application that initiated communication with the subsystem 120 via the proxy.

In the case of non-proxied requests, the nearest transport-layer device and the client endpoint are one and the same, e.g., the client device 108-1 for the request 112-1. In the case of proxied requests, however, the client endpoint does not reside at the nearest transport-layer device. In the context of FIG. 1, for example, the nearest transport-layer device involved in transmission of the client request 112-4 is the client device 108-3, but the client endpoint is the client device 108-4. The proxy detector 116 is configured, via the above-mentioned message inspection, to determine round-trip time periods associated with the transport-layer connection and the secure link, and to assess whether the client device 108 is likely to be operating as a proxy based on those time periods. Of particular note, the proxy detector 116 can perform the above-mentioned inspection and assessment without modifying the messages themselves or the processes by which the client devices 108 establish communications with the subsystem 120 (e.g., without delivering executable code or other content to the client devices 108 that would not have been delivered in the absence of the proxy detector 116).

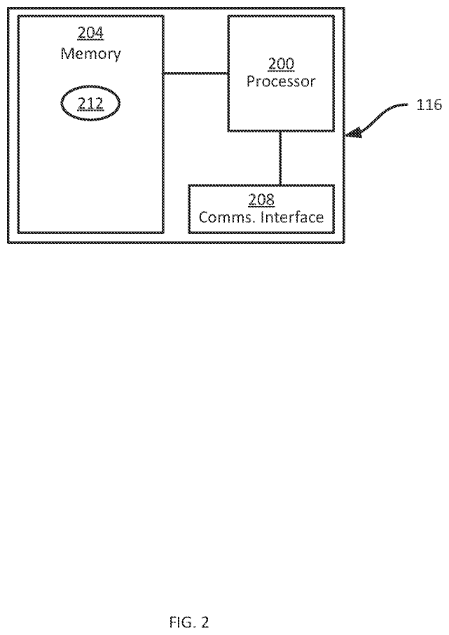

Before discussing the operation of the system 100, and in particular the functionality of the proxy detector 116, in greater detail, certain internal components of the proxy detector 116 will be described with reference to FIG. 2.

As noted above, the proxy detector 116 can be implemented as a server in the subsystem 120, distinct from the auxiliary detector 110 and the request handler 104. In the illustrated example, the proxy detector 116 includes at least one processor 200, such as a central processing unit (CPU) or the like. The processor 200 is interconnected with a memory 204, implemented as a suitable non-transitory computer-readable medium (e.g., a suitable combination of non-volatile and volatile memory subsystems including any one or more of Random Access Memory (RAM), read only memory (ROM), Electrically Erasable Programmable Read Only Memory (EEPROM), flash memory, magnetic computer storage, and the like). The processor 200 and the memory 204 are generally comprised of one or more integrated circuits (ICs).

The processor 200 is also interconnected with a communications interface 208, which enables the proxy detector 116 to communicate with the other computing devices of the system 100. The communications interface 208 therefore includes any necessary components (e.g., network interface controllers (NICs), radio units, and the like) to enable such communication. The proxy detector 116 can also include input and output devices connected to the processor 200, such as keyboards, mice, displays, and the like (not shown). In other examples, input and output devices can be connected to the proxy detector 116 remotely, via another computing device (not shown).

The components of the proxy detector 116 mentioned above can be deployed in a single enclosure, or in a distributed format. In some examples, therefore, the proxy detector 116 includes a plurality of processors, either sharing the memory 204 and communications interface 208, or each having distinct associated memories and communications interfaces. Implementing the proxy detector 116 in a distributed format can enable scaling of the computational resources available to the proxy detector 116, geographic distribution of the functionality provided by the proxy detector 116, and the like.

The memory 204 stores a plurality of computer-readable programming instructions, executable by the processor 200. The instructions stored in the memory 204 include a proxy detection application 212, execution of which by the processor 200 configures the processor 200 to perform various functions related to the above-mentioned inspection and assessment of message exchanged with the client devices 108 to detect client devices 108 operating as proxies. In some examples, the application 212 can be implemented as a set of distinct applications, e.g., a packet sniffer application to collect incoming and outgoing messages, and an analysis application to assess the above-mentioned time periods.

In other examples, as noted earlier, the proxy detector 116 can be implemented on computing hardware shared with either or both of the auxiliary detector 110 and the request handler 104. For example, the memory 304 can store not only the application 212, but also one or more other applications implementing the functionality of the detector 110 and/or request handler 104. In such embodiments, the application 212 is configured as the endpoint for communications addressed to the illustrated computing platform. That is, the application 212, and not the applications implementing auxiliary detection and/or response handling, is configured to handle the establishment of communications with client devices 108. Configuring the application 212 (or the proxy detector 116 more generally, if the proxy detector 116 is implemented in distinct hardware from the other components of the subsystem 120) as the endpoint enables the application 212 to inspect messages transmitted by the nearest transport-layer device, as well as the client endpoint.

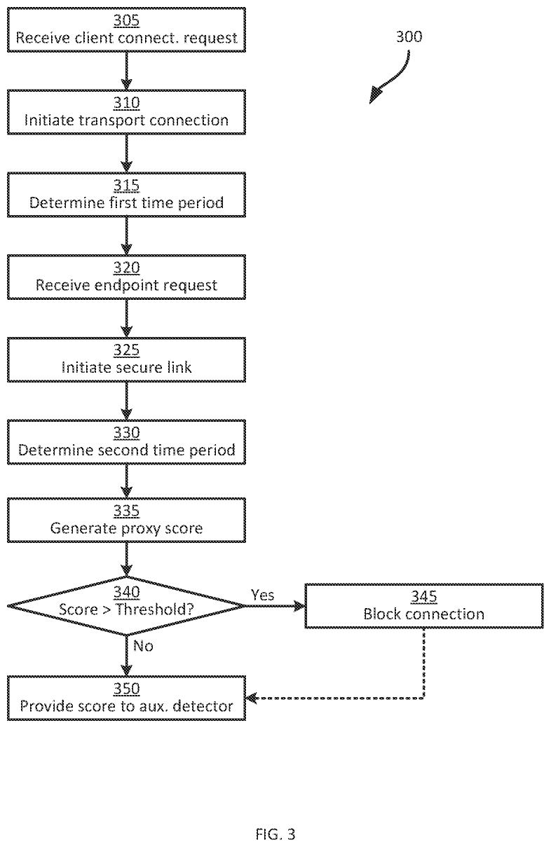

Turning to FIG. 3, a method 300 of proxy detection is illustrated. The method 300 will be described below in conjunction with its performance in the system 100, and in particular by the proxy detector 116, e.g., via execution of the application 212 by the processor 200.

At block 305, the proxy detector 116 is configured to receive a first request from a client device 108. The first request is a request to establish a transport-layer connection between the client device 108 and the proxy detector 116, e.g., a TCP-based connection as noted earlier. The request may include, for example, a TCP ‘SYN’ message containing a sequence number, an identifier of the client device 108, or the like.

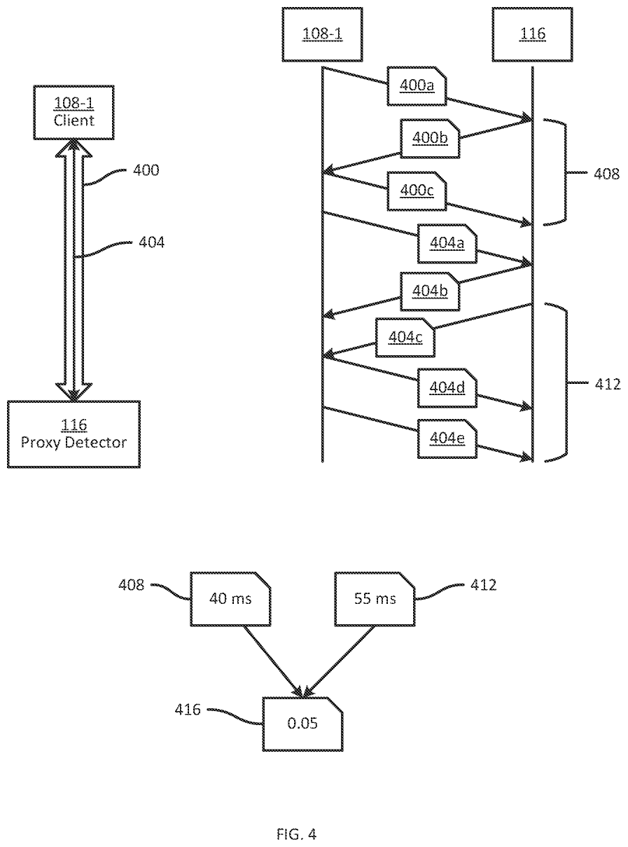

At block 310, in response to the first request received at block 305, the proxy detector 116 is configured to send a message (or the first in a series of messages, depending on the protocol employed to establish the transport-layer connection) to the client device 108, according to a handshake sequence defined by the relevant protocol. Turning briefly to FIG. 4, the client device 108-1 and the proxy detector 116 are shown in isolation, along with a sequence diagram illustrating various messages exchanged between the client device 108-1 and the proxy detector 116.

In particular, to establish a transport-layer connection 400, the client device 108-1 sends a first request 400a (e.g., the above-mentioned SYN message) to the proxy detector 116. The proxy detector 116, upon receiving the request 400a at block 305, can store a timestamp representing the time at which the request 400a was received. At block 310, the proxy detector 116 transmits a message 400b, such as a SYN-ACK message (in TCP-based embodiments), containing an acknowledgement of the request 400a, as well as a sequence number and/or other relevant information. The handshake sequence continues with a further message 400c from the client device 108-1, e.g., acknowledging the message 400b. In this example, following receipt of the message 400c at the proxy detector 116, the transport-layer connection 400 is established, and can be used to exchange other data, e.g., to establish a secure link 404, discussed further below. As will be apparent to those skilled in the art, the handshake sequence used to establish the connection 400 need not be exactly as discussed above, depending on the protocol employed to establish the connection 400.

The proxy detector 116 is also configured to store timestamps representing the time at which the message 400b was sent, and the time at which the message 400c was received. Returning to FIG. 3, at block 315 the proxy detector 116 is configured to determine a first time period, e.g., associated with the above-mentioned handshake sequence. In this example, at block 315 the proxy detector 116 is configured to determine a time period elapsed between the transmission of the message 400b (i.e., the initiation of block 310), and receipt of the message 400c. The measured time period, as will now be apparent, represents the round trip time (RTT) between the client device 108-1 and the proxy detector 116, and is illustrated as a time period 408 in FIG. 4. Although the RTT measurement at block 315 is discussed in connection with the handshake sequence for establishing the connection 400, in other examples the RTT can be determined after the connection 400 is established, e.g., from any other suitable pair of messages exchanged between the client device 108-1 and the proxy detector 116. A suitable pair of messages is a pair in which the first originates at the proxy detector 116, and the second necessarily follows the first and is expected to be transmitted by the client device 108-1 substantially immediately upon receipt of the first.

Returning to FIG. 3, at block 320 the proxy detector 116 is configured to receive a second request, to establish a secure link over the transport-layer connection (e.g., the connection 400 shown in FIG. 4). The secure link is between a client endpoint and the proxy detector 116, although it is not yet known whether the client endpoint is co-located with the client device 108 (i.e., with the device 108 from which the request at block 305 was received).

In response to the second request at block 320, the proxy detector 116 is configured to transmit a message initiating a handshake sequence according to a selected protocol, to establish a secure link with the client endpoint. In the present example, the protocol employed to establish the secure link is the TLS protocol, although other suitable protocols may be employed. It will be apparent that the handshake sequence involved in establishing the secure link will vary with the protocol employed at block 325.

Returning to FIG. 4, to establish the secure link 404 over the connection 400, the client device 108-1 can transmit a request 404a, such as a ‘Client Hello’ message as defined in the TLS protocol. For example, the request 404a can contain an indication of the supported protocol version (e.g., TLS 1.2 or 1.3), indications of cipher suites supported by the client device 108-1, a random number (e.g., for generation of a shared master secret, later used to generate encryption keys) and the like.

In response to the message 404a, the proxy detector 116 transmits a message 404b, such as an acknowledgment of the message 404a, to the client device 108-1. The proxy detector 116 can then transmit one or more further messages as dictated by the handshake sequence defined by the relevant security protocol. For simplicity of illustration, FIG. 4 shows one additional message 404c sent by the proxy detector 116. The message 404c can include, for example, the ‘Server Hello’ message as defined in the TLS protocol. The message 404c can contain a protocol version and cipher suites supported by the proxy detector 116, a further random number for later use in key generation. The message 404c can also include a server certificate, or the like.

In response to the message 404c, the client device 108-1 returns an acknowledgement message 404d, and can then send a final message 404e to complete the handshake sequence, such as a ‘Change cipher’ message in the TLS 1.3 protocol, or a ‘Client key exchange’ message in the TLS 1.2 protocol.

Referring again to FIG. 3, at block 330 the proxy detector 116 is configured to determine a second time period associated with the above-mentioned handshake sequence to establish the secure link 404. As noted earlier in connection with block 315, the proxy detector 116 is configured to maintain timestamps associated with the transmission of the messages 404b and 404c, as well as with the receipt of the messages 404a, 404d, and 404e. The time period determined at block 330 represents a round-trip time for the establishment of the secure link 404. That is, the RTT measured at block 330 is the time elapsed between the transmission of a message by the proxy detector 116, and the receipt of a following message (e.g., expected to be transmitted substantially immediately by the client endpoint in response to the message from the proxy detector 116) from the client endpoint. In the example shown in FIG. 4, the proxy detector 116 determines a second time period 412 elapsed between transmission of the message 404c, and receipt of the message 404e.

Of particular note, although the example shown in FIG. 4 involves determining the second time period based on messages exchanged during the handshake sequence, in other examples the time period can be determined based on other messages, after establishment of the secure link 404. The messages employed to determine the RTT at block 330 are selected, however, to ensure that they travel between the proxy detector 116 and the client endpoint, whether or not the client endpoint is behind a proxy. Thus, certain messages, such as acknowledgement messages, may not be suitable for use at block 330 because they cannot be guaranteed to have originated at the client endpoint. In the example of FIG. 4, the messages 404c and 404e are employed because the information contained in those messages is required to establish the secure link 404, and therefore cannot be generated by an intermediate proxy.

Upon determining the second time period 325, the proxy detector 116 is configured to generate a score indicating a likelihood that the client device 108 (e.g., the client device 108-1, in the example of FIG. 4) is operating as a proxy for the client endpoint. In other examples, the determination at block 315 can be performed substantially simultaneously with the determination at block 330, given that the proxy detector 116 can store timestamps associated with the messages exchanged during the above-mentioned handshake sequences and/or subsequent communications with the client device 108.

Generation of the score at block 335 is based on the first and second time periods, i.e., on the RTT associated with the transport-layer connection 400, and the RTT associated with the secure link 404. Turning to FIG. 4, solely for illustrative purposes, the first time period is assumed to be forty milliseconds, and the second time period is assumed to be fifty-five milliseconds. These time periods are provided byway of example only, and it will be apparent that varying network conditions between client devices 108 and the proxy detector 116 may lead to a wide variety of other time periods. However, it is expected that non-proxied client requests exhibit smaller differences between the first and second time periods than proxied client requests.

The score determined at block 335, therefore, assesses whether a difference between the first and second time periods indicates that the client device 108 with which the transport-layer connection is established is operating as a proxy for the client endpoint with which the secure link is established.

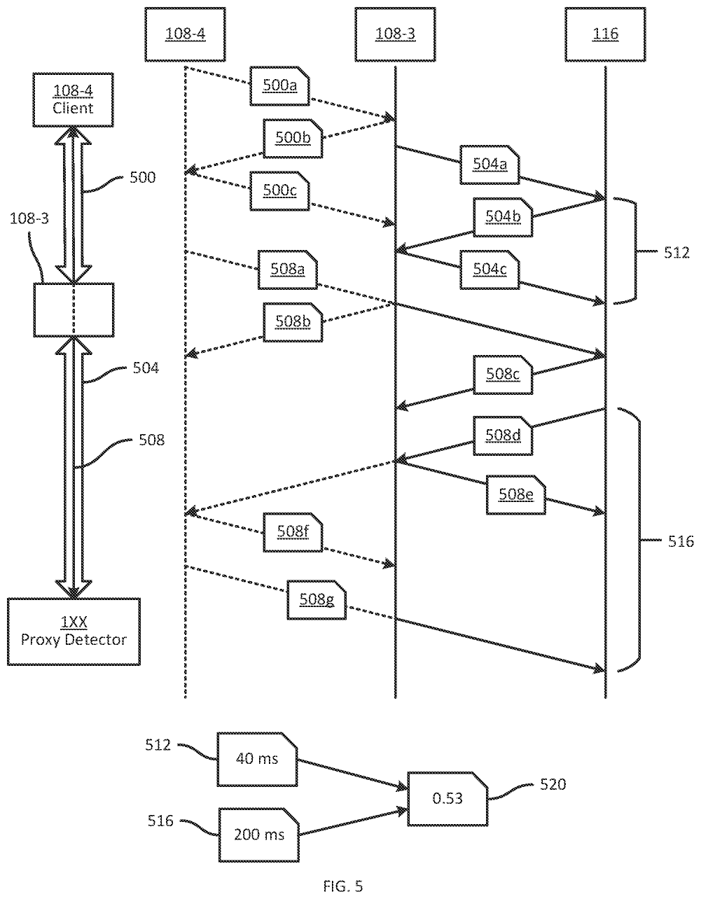

A wide variety of mechanisms for determining the score at block 335 are contemplated. For example, returning to FIG. 5, the proxy detector can determine a difference between the time periods 408 and 412 (e.g., fifteen milliseconds, in this example), and normalize that difference to a predefined range, based on a configurable maximum difference. For instance, the proxy detector can normalize the difference of fifteen milliseconds to a range between zero and one, with one representing a difference of three hundred milliseconds or more (e.g., the score can be capped at a value of one). In the illustrated example, therefore, the proxy detector 116 generates a score 416 of 0.05 (i.e., 15 ms/300).

In other examples, the score can be the difference itself, without normalization. In further examples, the score can be generated by determining the sum of the two time periods, and/or by normalizing the sum according to a predefined range. Various other mechanisms will also occur to those skilled in the art for generating the score. Any mechanism selected for generating the score at block 335 reflects the fact that when the transport-layer connection is established with a client device 108 that is also the client endpoint for the secure link subsequently established over the transport-layer connection, the separation between first and second time periods is expected to be relatively small. In contrast, when the transport-layer connection is established with a client device 108 that is not the client endpoint, the separation between the first and second time periods is expected to be greater. Thus, the score-generation mechanism is selected to produce higher (or lower) scores for greater differences between time periods, and lower (or higher) scores for smaller differences between time periods.

Following generation of the score at block 335, the proxy detector 116 can select a handling action for the client request 112, and/or for subsequent client requests 112 using the same secure link. For example, at block 340, the proxy detector 116 can be configured to compare the score to a threshold. In examples in which higher scores indicate higher likelihoods of proxying, therefore, the proxy detector 116 can determine whether the score exceeds a previously defined threshold. When the determination is affirmative, indicating that the relevant client device 108 is likely operating as a proxy, the proxy detector 116 can discard subsequent requests over the secure link at block 345, block/terminate the secure link previously established, or the like.

When the determination at block 340 is negative, the proxy detector 116 can forward any client requests received over the secure link to the auxiliary detector 110 and/or request handler 104, along with the score, at block 350. In some examples, blocks 340 and 345 are omitted, and the proxy detector 116 simply forwards the score and request(s) to the auxiliary detector 110. The auxiliary detector 110 can be configured to determine whether the request(s) are likely to have been generated by a bot, based at least in part on the score.

Turning to FIG. 5, another example performance of the method 300 is illustrated, to contrast with the performance shown in FIG. 4, in which the client device 108-1 itself is both the nearest transport-layer device and the client endpoint for secure communications. In FIG. 5, on the other hand, the client device 108-3 acts as a proxy for the client device 108-4.

Prior to receipt of a request a the proxy detector 116 at block 305, the client device 108-4 initiates a transport-layer connection 500 with the client device 108-3, e.g., via a three-way handshake sequence implemented via the messages 500a (e.g., a SYN message), 500b (e.g., a SYN-ACK message), and 500c (e.g., an ACK message). Either after establishment of the connection 500, or (as illustrated) contemporaneously with establishment of the connection 500, the client device 108-1 initiates a transport-layer connection 504 with the proxy detector 116. Specifically, at block 305 the proxy detector receives a message 504a (e.g., a SYN message). At block 310, via the messages 504b and 504c, the proxy detector 116 and the client device 108-3 complete the establishment of the connection 504. At block 315, the proxy detector 116 determines a first time period 512 associated with the transport-layer connection 504, such as the RTT between transmission of the message 504b and receipt of the message 504c.

Once the connections 500 and 504 are established, the client device 108-4 can request establishment of a secure link 508 over the connections 500 and 504. Of particular note, the secure link 508 tunnels through the client device 108-3, and therefore cannot be initiated by the client device 108-3 itself. As a proxy, the client device 108-3 is configured only to route encrypted communications between the client device 108-4 and the proxy detector 116, using the connections 500 and 504 (but without accessing the contents of such communications).

At block 320, therefore, the proxy detector 116 can receive a request 508a (e.g., a Client Hello message) from the client device 108-3. The request 508a was originated at the client device 108-4, although that fact is not visible to the proxy detector 116. The client device 108-3 may acknowledge the message 508a to the client device 108-4 via a message 508b.

At block 325, the proxy detector 116 is configured to initiate or continue the relevant handshake sequence to establish the secure link 508. For example, as noted earlier, the proxy detector 116 can send an acknowledgement message 508c, which may be relayed to the client device 108-4 in some examples, but is not in the illustrated example. The proxy detector 116 can then send a message 508d, such as the previously mentioned Server Hello message, containing information necessary to establish the secure link 508 (e.g., supported cipher suites, and the like). The message 508d is relayed to the client device 108-4, and acknowledged via the an ACK message 508e by the client device 108-3. The message 508e, however, is not used by the proxy detector 116 to determine a time period 516 associated with the secure link 508, because the message 508e cannot be guaranteed to have originated at the client endpoint. The message 508e, that is, does not contain information that can only be generated or otherwise provided by the client endpoint of the secure link 508, and therefore may not (and in the illustrated example, does not) represent a true RTT between the proxy detector 116 and the client endpoint.

Once the message 508d is received at the client device 108-4, the client device 108-4 may send an acknowledgement 508f, which is not forwarded to the proxy detector 116 in this example, but can be forwarded in other examples. The client device 108-4 then sends a message 508g to complete the handshake sequence and establish the secure link 508. The message 508g is analogous to the message 404e shown in FIG. 4. To determine the time period 516 at block 330, the proxy detector 116 determines the time elapsed between transmission of the message 508d, and reception of the message 508g. More generally, as noted earlier, the proxy detector 116 determines the time elapsed between a message transmitted from the proxy detector 116 that necessarily terminates at the client endpoint for the secure connection 508, and a subsequent expected message that necessarily originates at the client endpoint.

As seen in FIG. 5, the need to relay messages between the client devices 108-3 and 108-4 increases the time elapsed to complete the secure link 508, while the time required to complete the transport-layer connection 504 is unchanged relative to FIG. 4. That is, the presence of a proxy does not affect the connection 504, but lengthens the RTT associated with the secure link 508.

To determine a score at block 335, the proxy detector 116 can be configured, as in the example of FIG. 4, to determine the difference between the time periods 512 and 516, and to normalize that difference, e.g., against a maximum of three hundred milliseconds. The result, as shown in FIG. 5, assuming values of forty milliseconds and two hundred milliseconds for the time periods 512 and 516, is a score 520 of 0.53. That is, the score 520 is significantly higher than the score 416, indicating a greater likelihood that the client device 108-3 is operating as a proxy.

As will be apparent, therefore, the system 100 and specifically the proxy detector 116 enables the detection of proxied client requests 112 in a manner sufficiently robust to detect residential proxies that may be challenging to detect using previous proxy-detection mechanisms, and in a manner that does not require the deployment of executable code to client devices, or any modification to the message flows between client devices 108 and the proxy detector 116.

Specific example embodiments have been described above. Those skilled in the art, however, will understand that various modifications can be made to the above-examples, within the scope of above teachings. The scope of the claims below should therefore not be limited by the specific embodiments set forth in the above examples, but should be given the broadest interpretation consistent with the description as a whole.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

Those skilled in the art will further understand that in some embodiments, the functionality of the application 212 as described above may be implemented using pre-programmed hardware or firmware elements (e.g., application specific integrated circuits (ASICs), electrically erasable programmable read-only memories (EEPROMs), etc.), or other related components.

1. A proxy detection method in a server, the method comprising:
in response to receiving, from a client device, a first request to establish a transport-layer connection between the client device and the server, transmitting a first message to the client device according to a first handshake sequence, for establishing the transport-layer connection;
determining a first time period associated with completion of the first handshake sequence;
in response to receiving, from the client device over the transport-layer connection, a second request to establish a secure link between a client endpoint and the server, transmitting a second message to the client endpoint according to a second handshake sequence, for establishing the secure link;
determining a second time period associated with completion of the second handshake sequence; and
generating, based on the first time period and the second time period, a score indicating a likelihood that the client device is a proxy for the client endpoint.

2. The method of claim 1, wherein the transport-layer connection is based on the Transport Control Protocol (TCP).

3. The method of claim 2, wherein the first message includes a SYN-ACK message; and wherein the first time period is a time elapsed between transmission of the first message, and receipt of an ACK message from the client device.

4. The method of claim 1, wherein the secure link is based on one of (i) the Transport Layer Security (TLS) protocol, and (ii) the Secure Sockets Layer (SSL) protocol.

5. The method of claim 4, wherein the second time period is a time elapsed between transmission of the second message, and receipt of a next message from the client endpoint according to the second predefined handshake sequence.

6. The method of claim 1, wherein generating the score includes determining a difference between the first and second time periods.

7. The method of claim 1, further comprising selecting a handling action for future requests over the transport-layer connection, based on the score.

8. The method of claim 7, wherein the handling action includes discarding the future requests when the score exceeds a threshold.

9. The method of claim 1, further comprising providing the score to an auxiliary detector.

10. A server, comprising:
a communications interface; and
a processor configured to:
in response to receiving, from a client device, a first request to establish a transport-layer connection between the client device and the server, transmit a first message to the client device according to a first handshake sequence, for establishing the transport-layer connection;
determine a first time period associated with completion of the first handshake sequence;
in response to receiving, from the client device over the transport-layer connection, a second request to establish a secure link between a client endpoint and the server, transmit a second message to the client endpoint according to a second handshake sequence, for establishing the secure link;
determine a second time period associated with completion of the second handshake sequence; and
generate, based on the first time period and the second time period, a score indicating a likelihood that the client device is a proxy for the client endpoint.

11. The server of claim 10, wherein the transport-layer connection is based on the Transport Control Protocol (TCP).

12. The server of claim 11, wherein the first message includes a SYN-ACK message; and wherein the first time period is a time elapsed between transmission of the first message, and receipt of an ACK message from the client device.

13. The server of claim 10, wherein the secure link is based on one of (i) the Transport Layer Security (TLS) protocol, and (ii) the Secure Sockets Layer (SSL) protocol.

14. The server of claim 13, wherein the second time period is a time elapsed between transmission of the second message, and receipt of a next message from the client endpoint according to the second predefined handshake sequence.

15. The server of claim 10, wherein the processor is configured, to generate the score, to determine a difference between the first and second time periods.

16. The server of claim 10, wherein the processor is further configured to select a handling action for future requests over the transport-layer connection, based on the score.

17. The server of claim 16, wherein the handling action includes discarding the future requests when the score exceeds a threshold.

18. The server of claim 10, wherein the processor is further configured to provide the score to an auxiliary detector.
